(19) United States
(12) Patent Application Publication
(10) Pub. No.: US 2004/0156516 A1
(43) Pub. Date: Aug. 12, 2004

(54) Hearing aid with delayed activation

(75) Inventor: Rene Mortensen, Copenhagen V. (DK)

Correspondence Address: David G. Beck, Bingham McCutchen, LLP, 18th Floor, Three Embarcadero Center, San Francisco, CA, 94111, US

(73) Assignee: GN ReSound A/S

(21) Appl. No.: 10/359,915

(22) Filed: Feb. 7, 2003

(51) Int. Cl. H04R 25/00

(52) U.S. Cl. 381/312; 381/313; 381/317; 381/318

(57) ABSTRACT

A hearing aid (1) with microphone (2), an electrical or electronic circuit (3,6,12) for the processing of the signal from the microphone, and a sound transducer (13) for the generation of an acoustic output signal, and with an arrangement for switching the hearing aid on and off and an external storage unit (14) coupled together via a data bus (5,17), further comprising means which generate a special acoustic signal during or at least in part of a comfort delay period.

In this way a user will be able to ascertain whether the hearing aid is switched on and that it functions as it should.

The hearing aid further comprises delay means which, when the hearing aid is switched on, wholly or partly prevent the signal from the microphones (2) from reaching forward to the transducer (13) during a start-up period, e.g. during a comfort delay period in addition to the hearing aid's inherent delay period.

It can hereby be avoided that the hearing aid transmits a disturbing howling tone during the period until it is placed correctly at or in the ear of the user, if the user switches on the hearing aid before it is correctly positioned.

### STATE OF THE ART

The invention concerns a hearing aid of the kind disclosed in the preamble to claim 1, which in reality means almost all types of hearing aids to be found on the market.

Hearing aids are normally divided into three categories, i.e. behind the ear aids (BTE=behind the ear aid), in the ear aids (ITE=in the ear aid) or ear canal aids (CIC=completely in the canal aid).

From the purely technical point of view, such hearing aids can be configured both as so-called analogue aids and as digital aids, and as aids with a combination of analogue and digital techniques. The present invention can be used in connection with almost any form of hearing aid.

When a user switches on a hearing aid before it is positioned correctly at or in the ear, a high howling tone frequently arises because acoustic coupling between the sound transducer, i.e. a miniature loudspeaker, and the sound receiver, i.e. a microphone, makes the aid oscillate. This howling tone stops when the hearing aid is positioned correctly on or in the user's ear. BTE and ITE hearing aids usually have a mechanical on/off arrangement, e.g. a pushbutton, so that the user can wait to switch the aid on until it is correctly placed and thus avoid the oscillation. However, in order to ascertain whether the aid is functional, and whether there is a usable battery in the hearing aid, many users switch the hearing aid on before it is positioned at or in the ear. CIC hearing aids are so small that they rarely have a specific on/off arrangement. Such aids are switched on when a battery is inserted in the battery compartment and the battery cover is subsequently closed. When the battery cover is closed, the hearing aid is immediately switched on, i.e. that these types of aids are switched on before they are placed in the ear canal. The user can thus not avoid the howling tone until the aid is in place, which can be very troublesome. The howling tone can be extremely disturbing especially for users of CIC hearing aids, since these are often used by people with a slight or a moderate hearing loss.

To facilitate the understanding of the invention initially the following definitions are given:

“Start up period” is a time period that consists of the of sum two parts, namely

“inherent delay period” and “comfort delay period”.

The “inherent delay period” depends on the electronic design of the hearing aid, and the inherent delay is usually minimised during the design phase. If the hearing aid involved is of the analogue type, a charging of supply and coupling capacitors and possibly other components must take place before the aid is completely functional. If the aid involved is of the digital type, programmes or parts hereof must be read from non-volatile storage areas and transferred to volatile memory areas such as program RAM and/or data RAM. The inherent delay period for a hearing aid is usually at the most around 0.5 seconds and up to approx. 1 second for digital aids, where program instructions and program data etc. must be read. Efforts are also made, however, to make digital hearing aids functional after 0.5-1 seconds or less.

The “comfort delay period” is an additional time delay period wherein the acoustic signal from the microphone is, partly or wholly, prevented from reaching the sound transducer.

### DESCRIPTION OF THE INVENTION

By configuring a hearing aid according to a first aspect of the invention as disclosed and characterised in claim 1, i.e. the hearing aid comprises means which generate a special acoustic signal during or at least in part of a comfort delay period it is avoided that a user thinks that the aid is defective, that the battery is empty, or that the aid is incorrectly set if he is informed about the delay function. So instead of begin to adjust the aid during the delay period and perhaps hereby set it incorrectly, the user will wait for the aid to function.

In other words the user can ascertain, i.e. hear, that the aid is switched on and that it functions as it should, and in a number of seconds will be completely ready and functional.

It is noted, that in a prior art device, such as disclosed in DE 19526175, the device is silent in the delay period, leaving a user in doubt, whether the device is able to function or not.

As stated in claim 2, that the characteristics of the special acoustic signal are programmable, it is possible to input a preselected acoustic signal, via for example a PC, which is adapted to a certain user demands, e.g. the signal can be formed so the user can ascertain how great a part of the comfort delay period there remains.

This special acoustic signal can f. ex. be a series of short tones (“beeps”) at periodic intervals.

As stated in claim 3, that the characteristics of the special acoustic signal are programmable in the dependence of the users audiogram its possible to adapt the acoustic signal in a way such that the acoustic signal can comprise tones that naturally must be at a frequency and with a sound pressure that can be heard by the user.

Thus it is possible to fine adjust the special acoustic signal, f. ex. by adjusting the level of the individual frequency components in the signal as function of time.

It is also possible to reduce the interval between the “beeps” in the signal so that they arrive more frequently, or conversely so that they arrive more infrequently, as the end of the comfort delay period is approached.

When as stated in claim 4, the electronic circuit comprises amplification means adapted for reducing an amplification of the hearing aid during the comfort delay period, it is possible to avoid the possible, troublesome oscillation in a simple manner, and further by configuring the hearing aid as disclosed in claim 5 claim, a suitable down-regulation of the amplification is achieved, depending on the type of hearing aid involved, the setting of the hearing aid and the user's hearing impairment etc., so that a completely individual setting is achieved for the individual hearing aid user.

To further overcoming the disadvantages of the known hearing, it is preferred as disclosed and characterised in claims 6-7, that the delay is greater than 1 second, preferably greater than 3 seconds, or the comfort delay period is 5-30 seconds in length preferably 5-20 seconds, in order to adapt the aid to various users having different wishes.

With another aspect of the invention, efforts are also directed such that instead of aiming at making the start-up period as short as possible, it is aimed at giving the aid a start-up period of a user adapted time which can be done by configuring a hearing aid according to the invention as disclosed and characterised in claim 8, i.e. that the length of the start-up period is adjustable.

It is hereby achieved that the hearing aid can be adjusted to be completely or partly silent in a sufficient time until it has been positioned correctly. The user can thus avoid hearing the howling tone directly in the ear, even though the hearing aid has been switched on before it is positioned correctly at or in the ear.

Thus a comfort delay period will be provided for individual users demands or needs.

Especially with hearing aids without on/off switch, the period must be so long that the user, after having inserted the battery and hereby having switched on the aid, is able to place it correctly in the ear canal before the aid functions as it is has been set with regard to amplification, frequency response etc.

It is further noted that new users of hearing aids will need a long comfort delay period, but gradually as they become experienced in switching the aid on and placing it in position, they may be satisfied with a shorter period.

The length of the comfort delay period can also depend on the age of the user, or on how long the user has had the hearing aid etc. The length of the comfort delay period is set or chosen e.g. during the user's preliminary examination at the audiologist or the like, where the user can e.g. try different length.

The hearing aid can also be arranged as stated in claim 10, that the delay period means are adapted to reduce the length of the start-up period based on an accumulated utilisation time of the hearing aid

In this way the length of the start-up period will be reduced automatically, e.g. by some percent, each time the aid has been switched on a certain number of times since the last reduction.

This possible, automatic reduction may, as stated in claim 11, cease at a determined limit, e.g. when the comfort delay period has been halved in relation to the starting point.

Thus when a user get more experienced in the use of his hearing aid, and then need less time for the comfort delay period, then the hearing aid automatically reduces the comfort delay period.

The setting of the start-up period and the characteristics of the special acoustic signal can naturally also be selected as stated in claim 12, and carried out when the user consults the dealer, the audiologist or other qualified people who have fitting equipment for the hearing aid. The setting can be individual and such that the signal tones transmitted are at a level and frequency which are optimal for the user, e.g. the fitting equipment can be arranged in such a manner that it automatically selects a signal type and level on the basis of the user's own audiogram.

In the testing of the invention it has proved that many users have need for a comfort delay period which is of a length or is set to a length as disclosed and characterised in claim 13.

By configuring the hearing aid according to the invention as disclosed and characterised in claim 14 and 15, a comfort delay period of the desired length is obtained in a simple manner.

Within the scope of this invention, almost all requirements will be able to be covered for the different types of users and different types of hearing aids.

### THE DRAWINGS

In the following, a preferred embodiment of the invention is explained in more detail with reference to the drawings, where

FIG. 1 shows a simplified block diagram of a digital hearing aid with comfort delay period according to the invention, and

FIG. 2 is a flow diagram showing the start-up phase for the hearing aid in FIG. 1.

### DETAILED DESCRIPTION OF THE PREFERRED EMBODIMENT

The invention will now be described in more detail in connection with a fully digitalised hearing aid, e.g. a programmable CIC hearing aid.

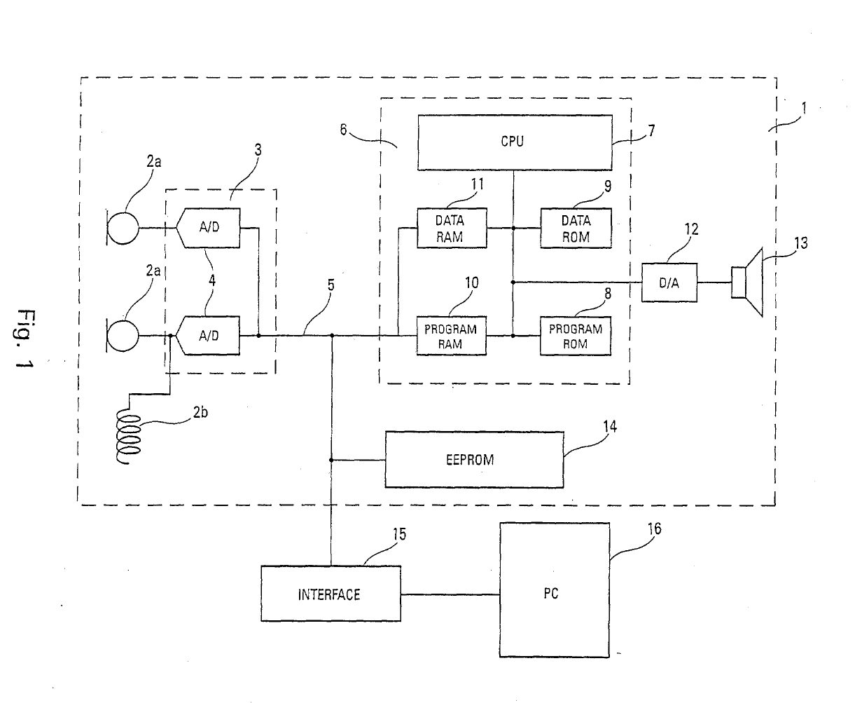

An example of such a hearing aid according to the invention is shown schematically in block diagram form in FIG. 1. The hearing aid, which is designated in general by the reference FIG. 1, contains one or more sound receivers 2, in the shown example two microphones 2a and a telecoil 2b. The analogue signals for the microphones are coupled to an analogue-digital converter circuit 3, which contains an analogue-digital converter 4 for each of the microphones.

The digital signal outputs from the analogue-digital converters 4 are coupled to a common data line 5, which leads the signals to a digital signal processing and adapter circuit 6. This circuit, which for example can be in the form of a digital signal processor (DSP), and which is explained in more detail later, is programmed to effect the necessary operations on the digital signals with the view to carrying out the necessary adaptation of the signals, and to adjust the hearing aid for the relevant user.

The output signal is then fed to a digital-analogue converter 12, from which analogue output signals are fed to a sound transducer 13, such as a miniature loudspeaker.

In addition, externally in relation to the digital signal processing and adapter circuit 6, the hearing aid contains a storage unit 14, which in the example shown is an EEPROM (electronically erasable programmable read-only memory). This external memory 14, which is connected to a common serial data bus 17, can be provided via an interface 15 with programmes, data, parameters etc. entered from a PC 16. This will be the case, for example, when a new hearing aid is allotted to a specific user, where the hearing aid is adjusted for precisely this user, or when a user has his hearing aid updated and/or re-adjusted to the user's actual hearing loss, e.g. by an audiologist.

The digital signal processing and adapter circuit 6, which in the example shown consists of a digital signal processor (DSP), contains a central processor (CPU) 7 and a number of internal storage units 8-11, these storage units containing data and programmes, which are presently being executed in the DSP circuit 6. The circuit 6 thus contains a programme-ROM (read-only memory) 8, a data-ROM 9, a programme-RAM (random access memory) 10 and a data-RAM 11. The two first-mentioned contain programmes and data which constitute permanent elements in the circuit, while the two last-mentioned contain programmes and data which can be changed or overwritten.

The external EEPROM 14 is normally considerably larger, e.g. 4-8 times larger, than the internal RAM, which means that certain data and programmes can be stored in the EEPROM so that, when there is need for it, they can be read into the internal RAMs for execution, in that these special data and programmes can thus later be overwritten again by the normal operational data and working programmes. The external EEPROM can thus contain a series of programmes, which are used only in special cases, such as e.g. start-up programmes.

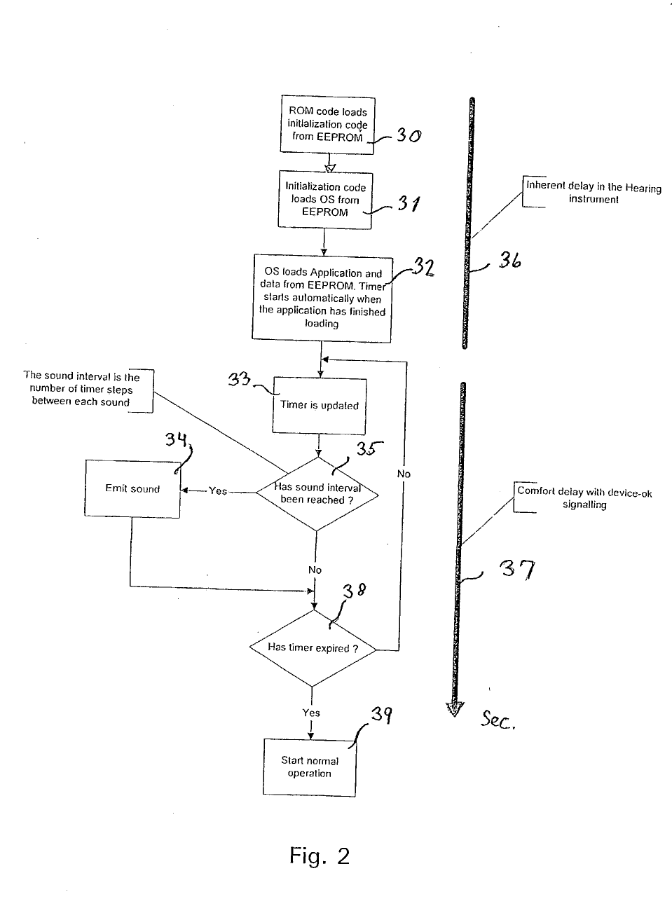

For an explanation of how the invention is implemented in the hearing aid, reference is made to the flow diagram in FIG. 2.

When the hearing aid is switched on, either by means of a regular, built-in switch, e.g. a pushbutton, or in the case of a CIC hearing aid by opening the battery cover, inserting a battery and closing the cover again, the inherent delay period 36 shown uppermost on the right-hand side is started, this period extending from the top and downwards along the symbolic time axis.

Hereafter, in a hearing aid of the kind shown in FIG. 1, a start code from the external EEPROM 14, cf. block 30 in FIG. 2, is transferred to the programme-RAM block 10 in FIG. 1. This start code gives rise to the transfer, cf. block 31 in FIG. 2, of an operating system from EEPROM 14 to the DSP circuit 6 in FIG. 1, after which, cf. block 32 in FIG. 2, the programme application and its associated data etc. are transferred by the operating system from EEPROM 14 in FIG. 1, so that the DSP circuit 6 is now completely operative and has been supplied with the necessary programmes, data etc., to customise the hearing aid for the individual user. Accordingly, the hearing aid is fully operative and, if it is not placed in position in the user's ear canal, it will oscillate due to the coupling between the transducer 13 and the microphones 2.

At the same time, however, a blocking of the signal path from the microphone 2 to the transducer 13 has been performed by one or several programme instructions, since what is involved is, of course, a programmable DSP 6.

At the same moment that the external memory 14 has transferred data, programme application etc. to DSP 6, a timer is automatically started in the DSP 6, cf. block 32.

The timer sequence starts and a count is effected from that number of seconds for which the aid's comfort delay period is set and down to 0, which is indicated in FIG. 2 by the logical steps 33, 38. When the timer, cf. block 38, has reached the expiry of the comfort delay period, the hearing aid is returned to normal, cf. block 39, in that the above-mentioned blocking is cancelled.

In the case shown, the timer is also used to control a block 34, see FIG. 2, which generates a short acoustic signal (“beep”) with a suitable frequency, cf. the logical step 35, in that the aid is programmed with that number of timer steps there must be between each beep. In this way, the hearing aid in FIG. 1 is programmed to implement the comfort delay period 37 in extension of the hearing aid's start-up period 36, and an acoustic signal 34 which notifies the user that the hearing aid is switched on and that it is operative, but that the comfort delay period has not yet expired.

If changes are desired in the comfort delay period 37, changes in the sound controlled by block 34 with regard to sound level, frequency, length of interval etc., these can be carried out by changing the programme sequence or just the parameters of sequence with which this is controlled, or by overwriting with a new programme sequence.

If the signal path from the microphone 2 to the transducer 13 is not desired to be blocked completely, but it is desired instead to reduce the hearing aid's amplification by a number of dB, e.g. 40-50 dB, this can also be effected in a programmable manner and independently of the sound level of the special acoustic signals controlled by block 34.

If, on the other hand, the hearing aid involved is of the analogue type or a hearing aid with combined analogue and digital technique, the comfort delay period can be controlled by a commonly-known time constant circuit, a digital counter or RC circuits.

If the hearing aid involved is an analogue aid, in practice use will often be made of a small digital circuit with a timer for controlling and setting the comfort delay period.

It will be obvious to those familiar with the art that in practice the present invention will be able to be implemented within the framework of the invention in ways other than those explained above.

1. Hearing aid (1) with at least one microphone (2a), an electrical or electronic circuit for the processing of the signal from the microphone and at least one sound transducer (13) for the generation of an acoustic output signal, and an arrangement for switching the hearing aid on and off and further comprising delay means which completely or partly prevent the signal from the microphone from reaching the sound transducer (13) during a start-up period when the hearing aid is switched on characterized in that the hearing aid comprises means which generate a special acoustic signal during or at least in part of a comfort delay period which is a time delay period wherein the acoustic signal from the microphone is, partly or wholly, prevented from reaching the sound transducer.

2. Hearing aid according to claim 1, wherein characteristics of the special acoustic signal are programmable.

3. Hearing aid according to claim 1 or 2, wherein the characteristics of the special acoustic signal are programmable in dependence of a users audiogram.

4. Hearing aid according to claim 1-3, wherein the electronic circuit comprises amplification means adapted for reducing an amplification of the hearing aid during the comfort delay period.

5. Hearing aid according to claim 4, wherein that the amount by which the amplification is reduced is set depending on a user's audiogram.

6. Hearing aid according to claim 1-5, wherein the comfort delay period is greater than 1 second, preferably greater than 3 seconds.

7. Hearing aid according to claim 1-6, wherein the comfort delay period is 5-30 seconds in length, preferably 5-20 seconds.

8. Hearing aid (1) with at least one microphone (2a), an electrical or electronic circuit for the processing of the signal from the microphone and at least one sound transducer (13) for the generation of an acoustic output signal, and an arrangement for switching the hearing aid on and off and further comprising delay means which completely or partly prevent the signal from the microphone from reaching the sound transducer (13) during a start-up period when the hearing aid is switched on, characterized in that the length of the start-up period is adjustable by setting the length of a comfort delay period which is a time delay period wherein the acoustic signal from the microphone is, partly or wholly, prevented from reaching the sound transducer.

9. Hearing aid according to claim 8, wherein the delay means are adapted to reduce the length of the start-up period based on an accumulated utilisation time of the hearing aid.

10. Hearing aid according to claim 8, wherein the start-up period is reduced from a first length to a second and final length.

11. Hearing aid according to claim 10, wherein the first length and the second and final length are settable to respective values during an initial fitting of the hearing aid.

12. Hearing aid according to claim 10 or 11, wherein the first length has a value between 10-20 seconds and the second and final length has a value between 3-9 seconds.

13. Hearing aid according to claim 8-12, wherein the delay means comprises a digital circuit (6) with digital storage facilities and means for the generation of a time-dependent signal or a clock function.

14. Hearing aid according to claim 8-13, further comprising means which generate a special acoustic signal during or at least in part of the comfort delay period.

15. Hearing aid according to claim 13-14, wherein the delay means are fully or partly implemented by a program sequence for controlling the length of the comfort delay period and/or the characteristic of the special acoustic signal.
